(19) United States
(12) Patent Application Publication
(10) Pub. No.: US 2007/0274819 A1
(43) Pub. Date: Nov. 29, 2007

(54) Process And Device For Processing Large Stamped Letters

(75) Inventors: Holger Schererz, Rehfelde (DE); Juergen Francke, Berlin (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/594,943

(22) PCT Filed: Feb. 3, 2005
(86) PCT No.: PCT/EP05/01067

§ 371 Date: Sep. 28, 2006

(30) Foreign Application Priority Data
Mar. 30, 2004 (DE) 10 2004 015 453.8

(51) Int. Cl. B07C 1/14

(52) U.S. Cl. 414/754

(57) ABSTRACT

To process large stamped letters, machine readable large letters are placed with the stamp facing upwards in a sorting station on a conveying means that leads them to further processing stations, has a reference edge in the conveying direction and is inclined in the conveying direction. The letter edge parallel to address lines, in proximity of which the stamps are located, rests against the reference edge. The stamps are automatically cancelled by a canceling device arranged over the leading-away conveying means and at a lateral spacing from the reference edge which corresponds to the spacing of the stamps from said letter edge. The large letters are then rotated through 90° as they are conveyed onwards with the shorter letter edge resting against the reference edge, by a locally fixed rotation element, so, like the standard letters, they rest with their longer letter edge on the reference edge, as is required for further processing.

Process and device for processing large stamped letters The invention relates to a method and to a device for processing large stamped letters according to the preambles of claims 1 and 10.

In postal pre-processing the incoming flows of mailings are separated in virtually all postal administrations for effective further processing. In the course of the process the letters are placed on their longitudinal edges and the position of the address field/stamps are oriented. The letters are also cancelled and possibly randomly checked for correct pre-payment (revenue protection). At the end of pre-processing the letters are provided appropriately sorted to further processing stations in the subsequent processes. Machine-readable standard letters, which are limited in terms of their thickness and their format dimensions, form the greatest proportion of the incoming mailings. This proportion is largely automatically processed. The second-largest proportion, the large letters, are mailings which exceed the standard letters in at least one parameter. Compared with canceling of standard letters, canceling of large letters is difficult. There are defined expected fields for the address and the stamps for standard letters. This is not the case with large letters. The wide variation in the dimensions of the mailing as well as in the arrangement of address and stamps on the mailing that consequently- exist means that a considerable degree of complexity is required to cancel these mailings fully automatically for example, so in practice manual canceling primarily takes place. The position of the stamps is usually guided by the position of the address field.

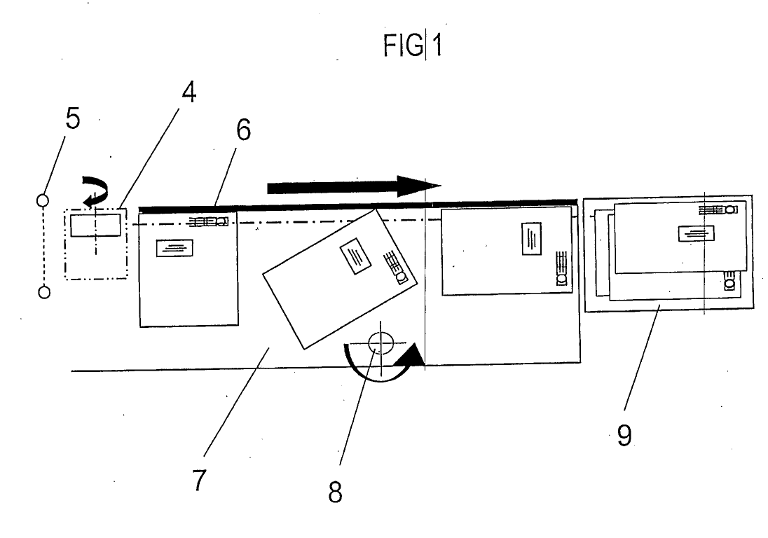

Two variants cover the huge majority of large letters (FIG. 1). Due to the traditional rectangular extent of the stamp field, some of the large letters have to be stamped cross-wise and others longitudinally when using a rectangular canceling imprint (for example by means of roller stamps).

The method according to which standard letters are positioned/canceled (stamping machines assume orientation along the longitudinal edge) cannot be used with large letters or can only be used for a subset of large letters.

To machine-process the stamped large letters further, longitudinally oriented removal/destacking is then necessary as a result of the input requirement into a large letter sorting system.

Division of the flow of letters into standard letters and large letters and positioning/orientation on the longitudinal edges can take place fully automatically, semi-automatically or manually at appropriate sorting stations. The device described in EP 1 185 473 B1 for handling piece goods is suitable for fully automatic sorting and orienting of the letters. In this connection rotating, obliquely arranged drums for sub-dividing the mailings according to thickness have also become known.

The object of the invention is to reduce the complexity when canceling large letters with different address orientation within the framework of pre-processing of mailing flows.

According to the invention the object is achieved by the features of claims 1 and 10.

The machine readable large letters are placed with the stamp at the top in a sorting station on a conveying means that leads them to further processing stations, has a reference edge in the conveying direction and is inclined in the conveying direction, such that the letter edge parallel to the address lines, in the proximity of which the stamps are located, rests against the reference edge. The stamps are automatically cancelled by a canceling device arranged over the leading-away conveying means and at a lateral spacing from the reference edge which corresponds to the spacing of the stamps from said letter edge. The large letters are then rotated through 90° as they are conveyed onwards with the shorter letter edge resting against the reference edge, by means of a locally fixed rotation element, so, like the standard letters, they thereafter rest with their longer letter edge on the reference edge, as is required for further processing.

Advantageous embodiments of the invention are illustrated in the sub-claims.

So that the canceling device is started at the right time, a sensor that detects the leading letter edge is advantageously provided. The start time of the canceling device for canceling the respective large letter is determined from the signal and spacing of this sensor from the canceling device and from the conveying speed.

It is also advantageous if the sensor detecting the leading letter edge, from the signal of which the start time of the canceling device for canceling the respective large letter is determined, is provided in the canceling device.

To increase the accuracy of the canceling procedure it is advantageous to determine the spacing of the stamps from the leading letter edge for each large letter and to incorporate this spacing into the determination of the respective start time of the canceling device.

Triggering of the canceling device may be simplified if the canceling procedures proceed over a fixed period.

It is also advantageous to provide as a canceling device a stamping device with a roller stamp which is resiliently pressed onto the large letter for canceling.

So that the letters of all accepted large letter formats may be rotated through 90° if they rest on the reference edge with their shorter letter edge, the spacing of the rotation element from the reference edge is greater than the greatest width and less than the smallest height of the accepted large letters.

For a non-complex configuration it is also advantageous to construct the rotation element as a rotatably mounted, upright cylinder.

To additionally assist rotation of the large letters it is advantageous if the cylinder is driven and comprises a direction of rotation which is opposite to the conveying direction.

The invention will now be described in an exemplary embodiment with reference to the drawings, in which:

FIG. 1 shows a diagrammatic plan view of a canceling device with adjoining rotating device,

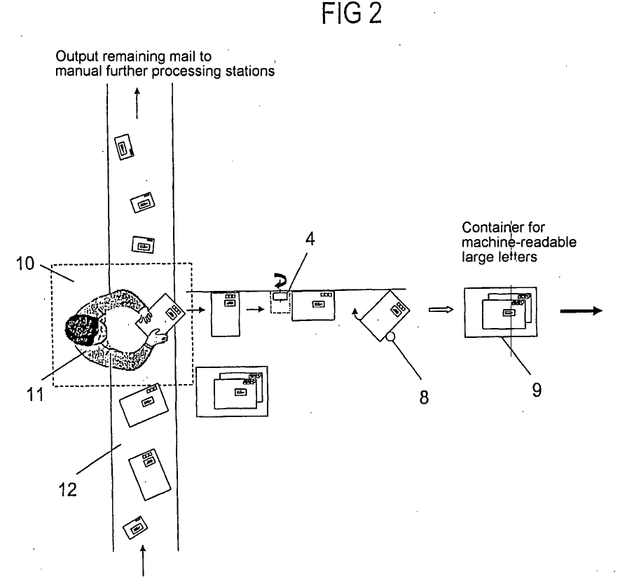

FIG. 2 shows a diagrammatic plan view of a canceling device at a manual sorting station,

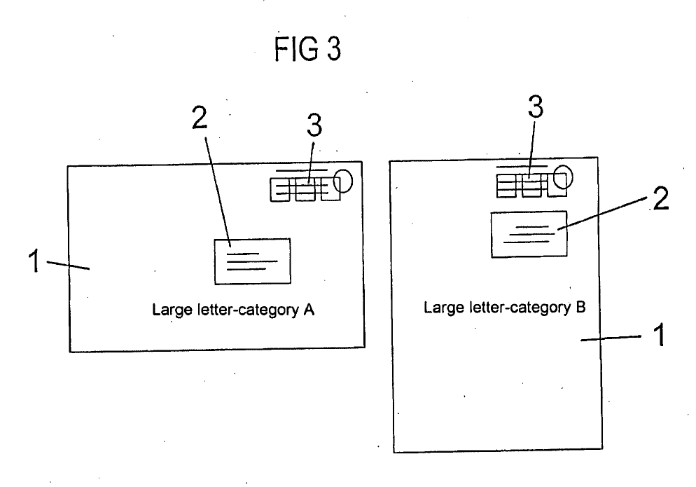

FIG. 3 shows a diagram of the most frequent large letters with address and stamp fields.

The address field and stamp field positionings that occur most frequently in the case of large letters are shown in FIG. 3. With the large letters 1 of category A with the long side at the top, as in the case of standard letters the stamp field 3 is located in the top right corner and the address field 2 for the destination address is located obliquely therebelow in a readable orientation. With the large letter 1 of category B arranged edgewise, the stamp field 3 is likewise located at the top right and the address field 2 therebelow if the short side is at the top (edgewise position). If canceling is to take place according to FIG. 1 with a locally fixed, non-displaceable canceling device, for example by using a roller stamp 4, the large letters of category A must therefore be fed in longitudinal orientation and the large letters of category B edgewise to the canceling device 4 by a conveying means 7, a conveyor belt in this case. If the leading edge of a large letter 1 is identified by means of a light barrier 5 at a defined spacing in front of the roller stamp, the canceling procedure is started so as to be synchronized with the conveying movement such that the canceling imprint is applied to the stamp 2. So that the canceling imprint is applied in a defined manner the large letters 1 have to be conveyed past the canceling device 4 appropriately oriented. This takes place in that the conveyor belt 7 is inclined toward a reference edge 6 and the large letters 1 slide onto the reference edge in the chosen orientation or at least remain on the reference edge during conveying. The spacing of the roller stamp from the reference edge 6 roughly corresponds to the spacing of the stamp 3 from the upper letter edge. After canceling the edgewise oriented large letters 1 have to be rotated through 90° so they can be processed further in the required longitudinal orientation. For this purpose a rotation element 8 in the form of a vertically oriented, rotatably mounted cylinder that is driven to assist the rotational procedure and of which the direction of rotation is opposite to the conveying direction is arranged downstream and closely above the conveyor belt 7, wherein the spacing of the rotation element 8 from the reference edge 6 is greater than the greatest width and less than the smallest height of the accepted large letters 1. The large letters 1 are then stacked in a conveying container 9 located at the end of the conveyor belt 7. It is of course also possible to guide the conveyor belt 7 up to a sorting station. The conveying means can also be at least partially constructed as a slide that is additionally inclined in the conveying direction. FIG. 2 shows the incorporation of this solution in a manual sorting station 10 at which an operator 11 sorts the machine-readable large letters 1 from the flow of mailings fed to a further conveyor belt 12 and as described places them so as to be oriented on the leading-away conveyor belt 7 extending perpendicular to the further conveyor belt 12. Sorting according to size is therefore very advantageously associated with canceling in this case. Instead of the manual sorting station an automatic sorting station can of course also be used for fully automatic sorting and orienting of the letters, as described in EP 1 185 473 B1. The sorting outputs are then equipped with a reference edge, as described above, the conveying means are inclined toward the reference edge and a canceling device and a rotation element are arranged accordingly.

1. A method for processing large stamped letters, wherein the large letters (1) are fed, lying on a conveying means (12) and mixed with other mailings, to a sorting station (10) at which the a flow of mailings is divided at least into machine-readable large letters (1) and other mailings,
characterized in that wherein
the machine-readable large letters (1) are placed with the stamps (3) at the top facing upwards in a sorting station (10) on a conveying means (7) that leads them to further processing stations, wherein the conveying means has a reference edge (6) in the a conveying direction and is inclined in the conveying direction,
the a letter edge parallel to the address lines, in the proximity of which the stamps (3) are located, rests against the reference edge (6),
the stamps (3) are automatically cancelled by a canceling device (4) arranged closely above the leading-away conveying means (7), and at a lateral spacing from the reference edge (6) which corresponds to the a spacing of the stamps (3) from said letter edge, and
and that a locally fixed rotation element (8) then rotates through 90° the large letters (1) as they are conveyed onwards with the a shorter letter edge resting against the reference edge (6), so that thereafter the a longer letter edge likewise rests on the reference edge (6).

2. The method as claimed in of claim 1, characterized in that wherein a sensor (5) that detects the a leading letter edge is provided, and wherein from the a signal generated by the sensor and spacing from the canceling device (4) of which and from the conveying speed, the a start time of the canceling device (4) for canceling the respective large letter (1) is determined.

3. The method as claimed in of claim 2, characterized in that wherein the sensor (5) detecting the leading letter edge, from the signal of which the start time of the canceling device (4) for canceling the respective large letter (1) is determined, is provided in the canceling device (4).

4. The method as claimed in of claim 2 or 3, characterized in that wherein the spacing of the stamps (3) from the leading letter edge is determined for each large letter (1) and this spacing is incorporated into the determination of the respective start time of the canceling device (4).

5. The method as claimed in of claim 2 or 3, characterized in that wherein the canceling procedure proceeds over a fixed period of time.

6. The method as claimed in of claim 1, characterized in that wherein provided as a canceling device (4) is a stamping device with a roller stamp which is resiliently pressed onto the large letter (1) for canceling.

7. The method as claimed in of claim 1, characterized in that wherein the spacing of the rotation element (8) from the reference edge is greater than the a greatest width and less than the a smallest height of the accepted large letters (1).

8. The method as claimed in of claim 7, characterized in that wherein the rotation element (8) is constructed as a rotatably mounted, upright cylinder.

9. The method as claimed in of claim 8, characterized in that wherein the cylinder is driven and has a direction of rotation which is opposite to the conveying direction.

10. A device for processing stamped large letters, comprising a sorting station (10) at which a flow of mailings fed to a conveying means (12) is divided at least into machine-readable large letters (1) and other mailings, characterized by wherein:
a conveying means (7) that leads the machine-readable large letters (1) in a horizontal position from the sorting station (10) to further processing stations and has a reference edge (6) in the a conveying direction and is inclined in the conveying direction, the large letters (1) to be lead away being placed on the leading-away conveying means (7) with the stamps (3) at the top facing upwards such that the letter edges parallel to the address lines, in the proximity of which the stamps (3) are located, rest against the reference edge (6),
a canceling device (4) arranged closely above the leading-away conveying means (7) and at a spacing from the reference edge (6) which corresponds to the spacing of the stamps (3) from said letter edge, and
a locally fixed rotation element (8) arranged downstream and rotating through 90° the large letters (1) as they are conveyed onwards with the a shorter letter edge resting against the reference edge (6).

11. The device as claimed in of claim 10, characterized in that wherein a sensor (5) that detects the leading letter edge is provided, and wherein from the a signal generated by the sensor and spacing from the canceling device (4) of which and from the conveying speed, the a start time of the canceling device (4) for canceling the respective large letter (1) can be determined.

12. The device as claimed in of claim 11, characterized in that wherein the sensor (5) detecting the leading letter edge, from the signal of which the start time of the canceling device (4) for canceling the respective large letter (1) is determined, is provided in the canceling device (4).

13. The device as claimed in of claim 10, characterized in that wherein provided as a canceling device (4) is a stamping device with a roller stamp which can be resiliently pressed onto the large letter (1) for canceling.

14. The device as claimed in of claim 10, characterized in that wherein the spacing of the rotation element (8) from the reference edge (6) is greater than the a greatest width and less than the a smallest height of the large letters (1).

15. The device as claimed in of claim 14, characterized in that wherein the rotation element (8) is constructed as a rotatably mounted, upright cylinder.

16. The device as claimed in of claim 15, characterized in that wherein the cylinder is driven and has a direction of rotation which is opposite to the direction of conveying.
